(19) United States
(12) Patent Application Publication
(10) Pub. No.: US 2010/0174772 A1
(43) Pub. Date: Jul. 8, 2010

(54) Comprehensive data collecting, processing, and management system capable of being remotely managed and monitored in real time

(76) Inventor: James Hans Beck, Atascadero, CA (US)

Correspondence Address: LAW OFFICES OF ANDREW SCHROEDER, P.O. Box 6731, Santa Maria, CA, 93454, US

(21) Appl. No.: 12/319,160

(22) Filed: Jan. 2, 2009

(51) Int. Cl. G06F 15/16; G06F 21/00; G06F 9/46; G06Q 10/00; G01C 21/00; G06K 7/10

(52) U.S. Cl. 709/203; 726/4; 718/100; 705/30; 705/9; 701/213; 235/472.03; 235/462.01

(57) ABSTRACT

A system, apparatus, and method for collecting, processing, and directing operators in the field in real time includes a client system, a server based management system, a field transceiver system, and a financial system. The client system comprises a network-based portal linked to a plurality of web pages for the purpose of interfacing with a client. The security system is included for the purpose of ensuring authorization and encryption protection. The software is adapted for the purpose of organizing, filtering, tabulating, and processing data gathered in the field according to client's preferred processing guidelines.

### FIELD OF THE INVENTION

The present invention relates with an apparatus, system, and method of data collection capable of being managed, directed, uploaded and downloaded in real time.

### BACKGROUND OF THE INVENTION

The task of data collecting and gathering is encumbered with a panoply of problems. Utilities companies are faced with the ordeal of having to send out large teams of personnel who navigate the city streets to read meters. These operators are nearly isolated out in the field by themselves. Although they may have a radio or cell phone, they may feel uncomfortable asking for directions from a supervisor or another operator.

Oftentimes, these operators become confused, frustrated, and disoriented due to the lack of guidance as to which objects they are supposed to read or scan. Moreover, more often than not, there is very little oversight ability ensuring that these operators are performing their jobs accurately at all.

Another problem which inheres with current technology is the use of hand held readers which must be cradled several times a day. This cradling process is wasteful because it brings a person off the job site and back to the office. The cradling process is used to upload various information from the client to the handheld device and vice versa. It is also used to re-energize the batteries in the device. Furthermore, these devices are exorbitantly expensive because they are specifically designed to perform a very specific problem. Accordingly, these devices may not be used for other operations the organization may have.

Another problem with the state of the art is that it cannot effectively use their personnel to maximize production. Oftentimes there will be experienced operators with superior physical attributes and experience who may complete a route or task early while there may be other operators who fall behind leaving many objects unread. Due to the inability of management to track the progress and location of their operators in real time, they are not able to re-assign, or summon an operator who has just finished to help another operator who may be falling behind in their routes or assignments.

Therefore, what is clearly needed in the art is a system, apparatus, and method for directing, coordinating, and collecting data in the field. The system should use “off the shelf” items, technologies, and software which are cost effective. The system should also be enabled to work across various platforms, architectures, and software. The system should also utilize multi-functional devices capable of transmitting, receiving, processing, data collecting, and monitoring in real time. The system should also enable a person to closely monitor the process of the data gathering in real time thereby enabling that person to make appropriate adjustments in task assignments and routing of the operators.

### SUMMARY OF THE INVENTION

It is an object of the present invention to provide a system and apparatus for the purpose of directing various data collecting tasks. In some preferred embodiments the present invention can be used for the purpose of collecting data for municipalities such as collecting data for water usage, electricity usage, gas usage, and the like. In other applications the present invention may be used in warehouses, stores, distribution centers, libraries, etc. for the purpose of tracking various products.

### BRIEF DESCRIPTION OF THE DRAWING FIGURES

FIG. 1 is a block diagram of a preferred embodiment of the present invention.

FIG. 2 is a block diagram of a preferred embodiment of the present invention.

FIG. 3 is a block diagram of a preferred embodiment of the present invention.

FIG. 4 is a block diagram of a preferred embodiment of the present invention.

FIG. 5a is a block diagram of a preferred embodiment of the present invention.

FIG. 5b is a plan view of a preferred embodiment of the present invention.

FIG. 5c is a plan view of a preferred embodiment of the present invention.

FIG. 5d is a plan view of a preferred embodiment of the present invention.

FIG. 5e is a plan view of a preferred embodiment of the present invention.

FIG. 5f is a plan view of a preferred embodiment of the present invention.

FIG. 5g is a plan view of a preferred embodiment of the present invention.

FIG. 5h is a plan view of a preferred embodiment of the present invention.

FIG. 6 is a plan view of a preferred embodiment of the present invention.

FIG. 7 is a side view of a preferred embodiment of the present invention.

### DESCRIPTION OF PREFERRED EMBODIMENTS

According to a preferred embodiment of the present invention, a unique system, apparatus, and method are used to maximize efficiency and organization within businesses and organizations. Moreover, the system described herein is used for the purpose of directing operators in the field for the purpose of data collecting. The system, apparatus, and method are described in enabling detail below.

For the purposes of the present invention the term “Transceiver” shall include any handheld personal digital assistant comprising logic, software, and wireless networking means capable of communication with a remote server.

For the purposes of the present invention the term “Internet” or “Network” shall be interchangeable. The term “Internet” shall refer to the information system which comprises the World Wide Web (www), the largest publicly accessible source of information in the world. The term “Network” shall refer to an intra-organizational cluster of computers or other device which are linked to each other.

For the purposes of the present invention the term “webpage” shall include any page linked to a portal for the purpose of practicing the present invention. The term may be used in either a Network setting or when use with the Internet or World Wide Web.

For the purposes of the present invention the term “computer” shall hereafter refer to those devices which are adaptable as a network appliance and are able to execute various software typically used in many businesses or other organizations. Several types of devices may be encompassed by the term “computer” which may include cellular telephones, personal digital assistants, laptop computers, or desktop computers.

For the purposes of the present invention the terms “organization” or “business” shall be interchangeable. The present invention is equally expedient for use with non-profit organizations, public sector organizations and similar institutions because many public sector/non-profit functions and tasks are just as pertinent and essential as they are with private sector, for-profit businesses.

For the purposes of the present invention the terms “operator” shall refer to any person in the field at the job site, work site, or location which requires the data gathering and collection services.

For the purposes of the present invention the term “client” can alternately refer to the owner, manager, or sole proprietor. Moreover, the term “client” can also refer to the business or organization as a whole. Therefore, when the system of the present invention communicates with an employee of the business, the term “employee” can be substituted for the client.

For the purposes of the present invention the term “scanning component” shall refer to those devices which acquires information from other devices, products, etc. Examples include wands, bar code readers, and similar instruments.

For the purposes of the present invention the term “wand” shall mean any device or apparatus which collects or gathers information either wirelessly or through contact. The wand may be integrally incorporated within the transceiver device. Or in the alternative, the wand may be a separate stand-alone device in communication with the transceiver.

For the purposes of the present invention the term “indicia” not only comprises printed illustrations, markings, bar codes and the like, but also further comprises information which inheres with various magnetic fields or similar technology. For instance, the term “indicia” shall further comprise that information transmitted and received through use of near-field technology.

For the purposes of the present invention the term “real time” shall generally describe the contemporaneous ability of a manager or director to monitor the progress or location of the various assignments at that particular moment in time. A manager or director can access the server to show precisely where the operator is located and how far that operator has progressed to that specific moment in time.

For the purposes of the present invention the term “handheld” shall mean any apparatus which is reasonably portable. This term should not be construed to require an operator or other person to literally carry the device in one's hand. The device could be operated or carried in a bag, belt, on their person, etc.

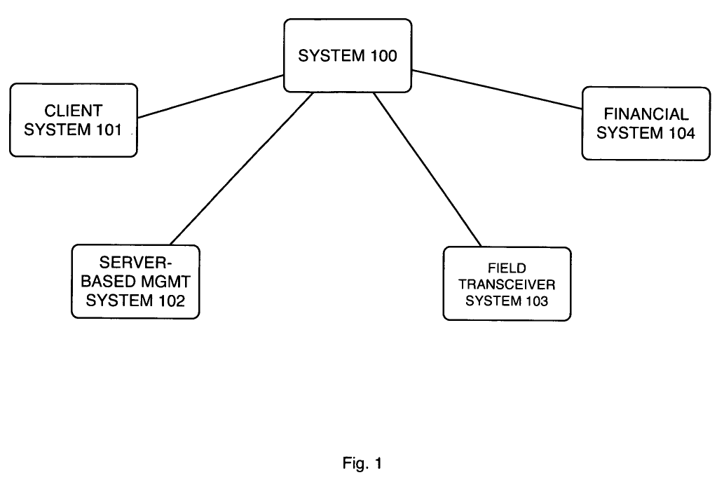

FIG. 1 illustrates one preferred embodiment of the present invention. The system 100 for collecting, processing, and directing operators in the field in real time includes a client system 101, a server based management system 102, a field transceiver system 103, and a financial system 104.

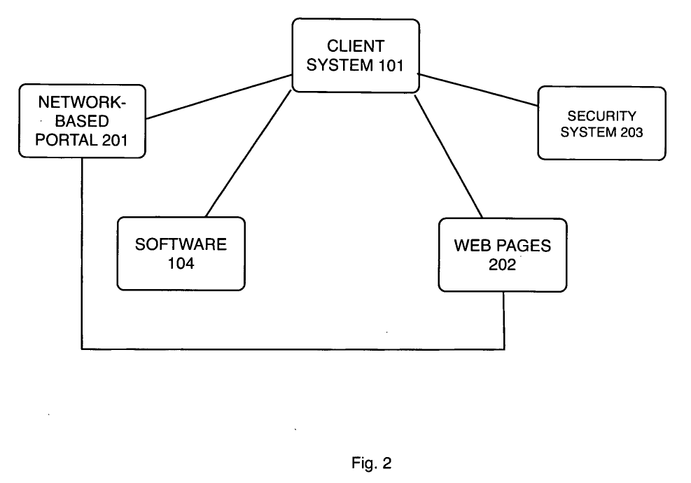

FIG. 2 illustrates a preferred embodiment including the Client System 101. The client system comprises a network-based portal 201 linked to a plurality of web pages 202 for the purpose of interfacing with a client. The security system 203 is included for the purpose of ensuring authorization and encryption protection. The security system is used for the purpose of limiting or restricting access to unauthorized persons, computers, servers, or other apparatuses. The software 104 is adapted for the purpose of organizing, filtering, tabulating, and processing data gathered in the field according to client's preferred processing guidelines.

In some preferred embodiments, the portal will have a home page with a request for a username along with its attendant password. If the correct username and password is entered by the client, the client may then enter into various pages within the website. In some preferred embodiments there may be varying levels of access due to varying levels of authorization. In other words, if the client is a large corporation or utilities company, various employees or personnel in those departments may be enabled to view only certain compartments of the website and may be restricted from access to other areas of the website.

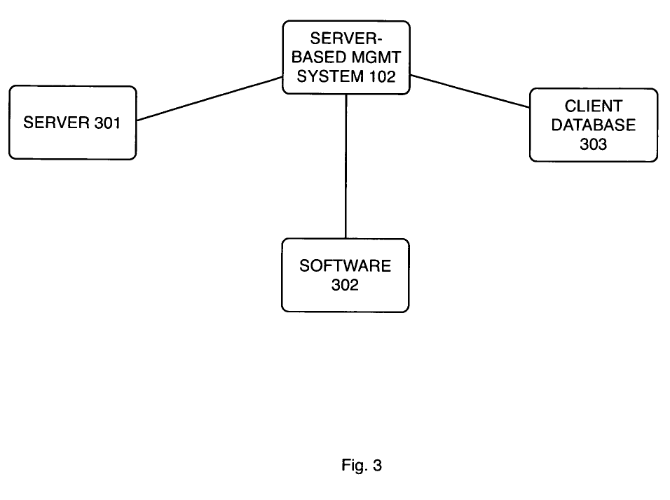

FIG. 3 illustrates an exemplary embodiment of a server based management system. The server based management system 102 incorporates a server 301, software 302, and a client database 303. The server is in communication with the database and the field transceiver system handled by the operator. The server may link with the transceiver system through a panoply of different telecommunications conduits. Wi-Fi, Bluetooth, hotlink, and cellular may be used to act as an expedient conduit for information exchange.

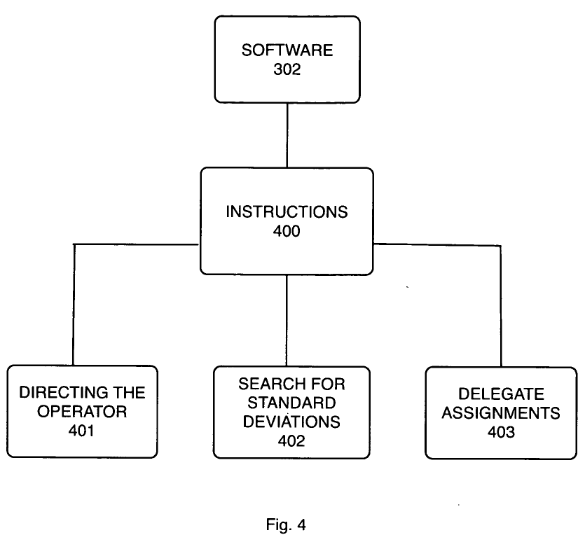

FIG. 4 illustrates an exemplary embodiment of the software used with the server based management system. The software 302 comprises instructions 401 for directing the operator, searching 402 for data entries gathered by the operator which exceed standard deviations, and for delegating 403 assignments to the operator(s). In some preferred embodiments (enabled with global positioning devices) tasks, routes, and assignments may be disseminated directing the location and tracking of the operator. Various routing software which may comprise maps, tree-style screens may be incorporated which clearly show the operator in which direction and sequence he must move.

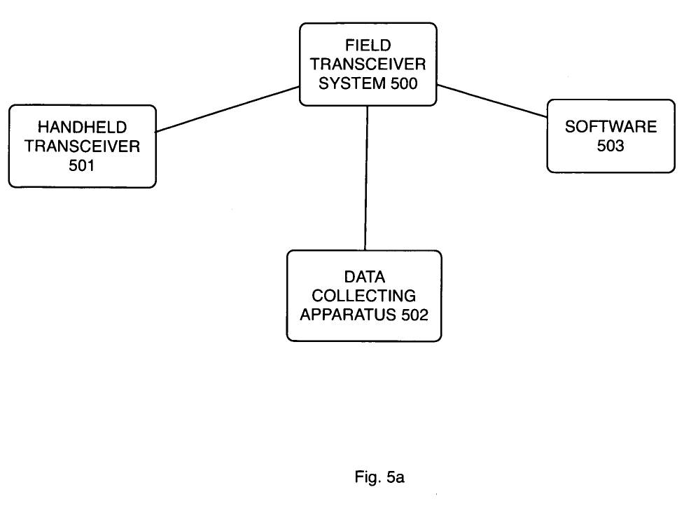

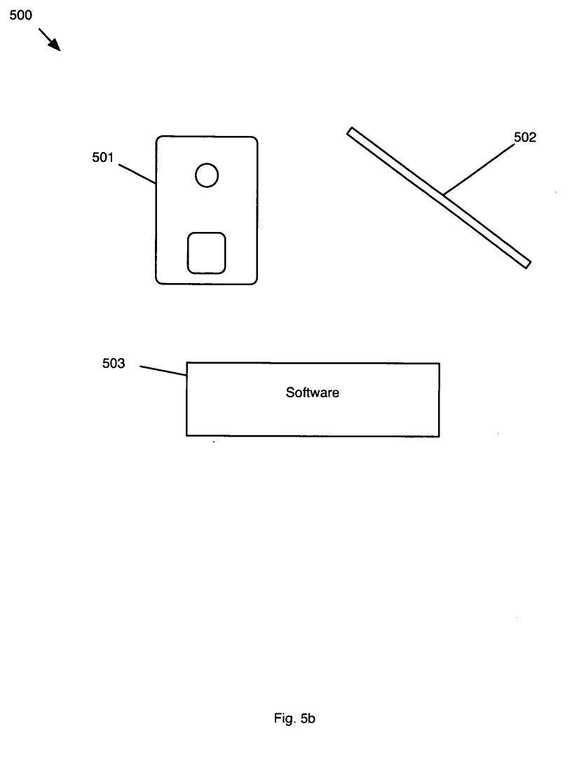

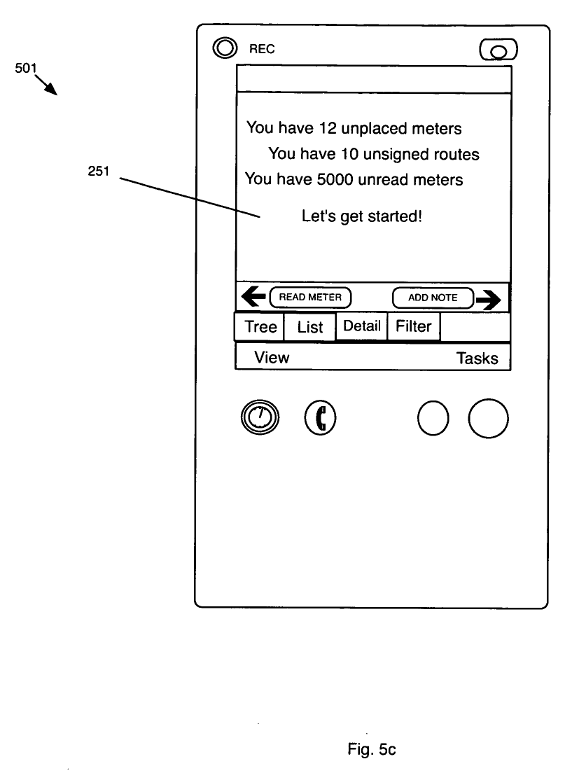

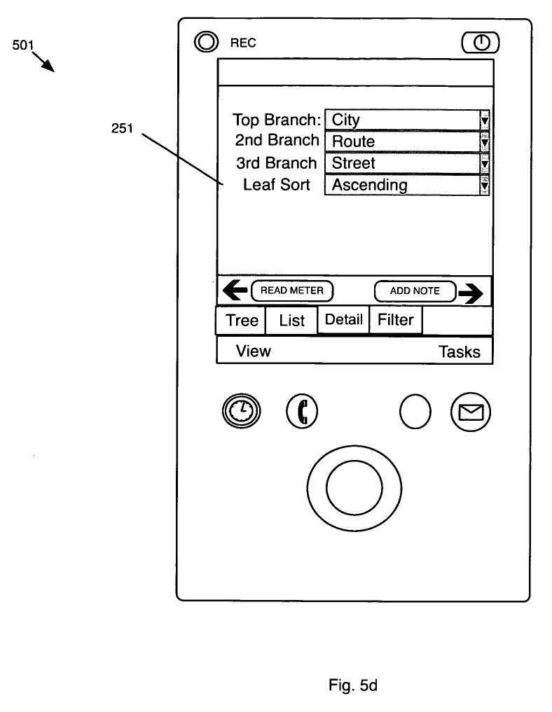

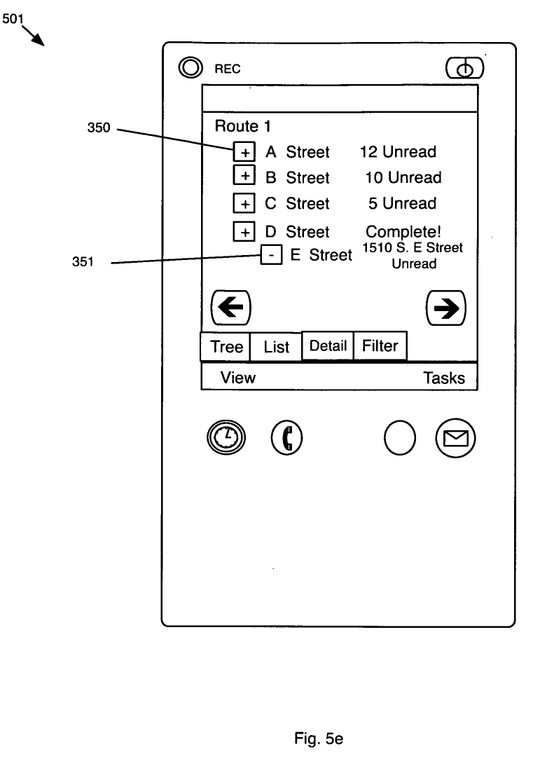

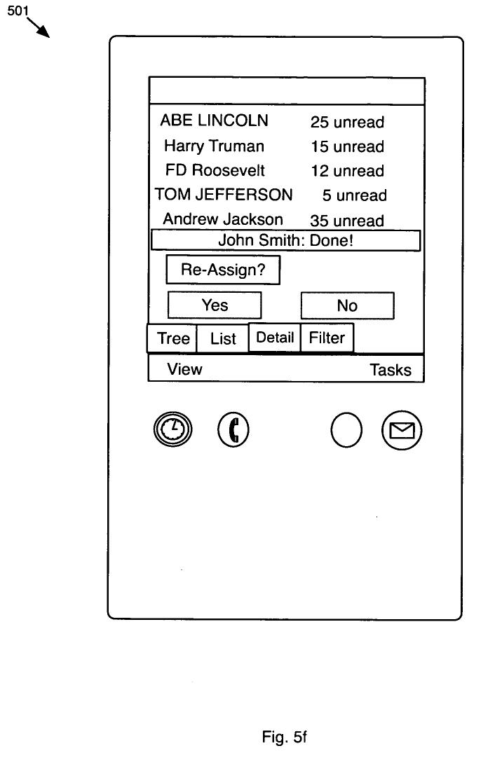

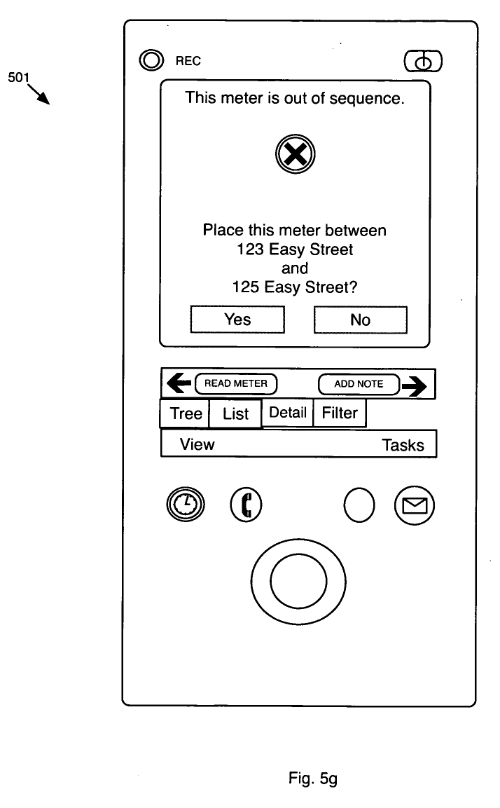

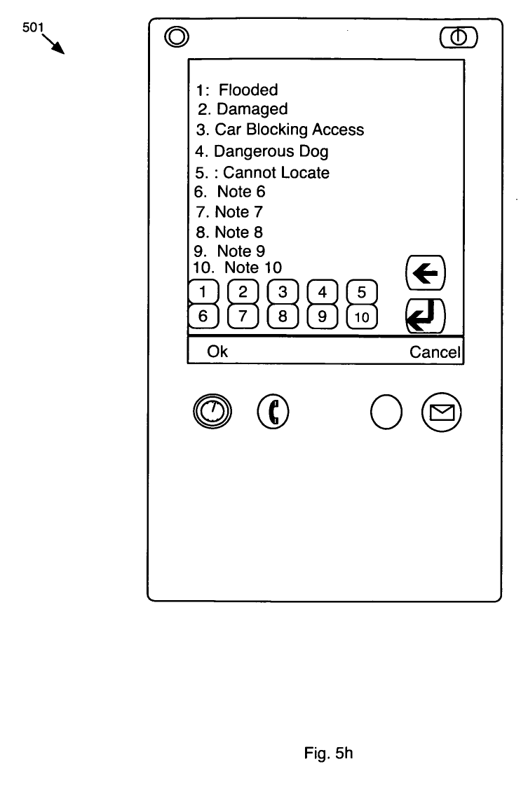

FIG. 5a illustrates a preferred embodiment including an exemplary field transceiver system. The field transceiver system 500 includes a handheld transceiver 501, a data collecting apparatus 502, and software 503 for directing the operator through assignments. The handheld transceiver in communication with the server based management system. In other preferred embodiments the handheld transceiver may be a multi-function device incorporating such functions as: telecommunications, web-browsing, laser-enabled bar-code reading, computing, radio communications, etc. Typical devices include Blackberry® (Blackberry is a registered trademark cellular phones, personal digital assistants, and the like. In some preferred embodiments, the handheld transceiver is a handheld personal digital assistant comprising logic and software typically found on most computers.

In some preferred embodiments the data collection apparatus may be a wand. The wand is a tool which collects data either remotely or through contact with the subject of the data collection. For instance, some utilities companies have enabled utility devices at various residences, office buildings, and the like to send a weak signal which comprises information about the amount of energy or resources used. By simply passing the wand near this utility device, data from the signal will show how many units of electricity, water, gas, or other resource has been used by the occupant.

In some preferred embodiments the wand may further comprise a bar-code reader. Using technologies known to those skilled in the art, the bar code reader wand may be used to generate inventory lists in a retail store. It may also be used to inventory other supplies which have a bar code imprinted upon the packages. One example may be industry-standard bar code readers used by bookstores.

In other preferred embodiments the wand may incorporate near field technology. The wand may be able to simply pass over a near-field adapted apparatus and receive data inputs through the apparatus.

Some wands are capable of gathering data through contact. These wands are typically used in the agriculture and scientific research industries. These wands may detect such properties of water, soil, and the like of pH, salinity, alkalinity, radiation, heat, electricity, radon, and the like.

The system may also incorporate software for the purpose of directing the movements of an operator to collect the data in an accurate and sequential way. In some preferred embodiments, the software will provide in precise detail the routes an operator is to follow. If the operator deviates from the route, the operator may be instructed by the server to comply with sequence protocols in order to ensure accurate data gathering.

FIG. 5c illustrates a preferred embodiment of an exemplary software system to be used with the handheld transceiver. The screen 251 illustrates an introductory start phase where a manager or operator may commence the operation. Typical information would be how many routes, how many meters, and how many employees or operators are assigned to the operation.

FIG. 5e illustrates that in some preferred embodiments the tree 252 view displays routes or assignments on a tree-diagram structure. When an element of a tree diagram is tapped twice (other preferred embodiments may use other methods) the element displays a sub-set of elements. For instance, in FIG. 5e, A Street, B Street, C Street and D Street are the primary elements 350. When any of the primary elements are tapped twice by the operator the primary element illustrates sub-elements 351 which it comprises. In this example Primary element E Street reveals sub-element 1510 S. E Street “unread”. This sub-element may, in turn, comprise other sub-elements as well.

This software may also incorporate various mapping software which is GPS enabled. This software may enable a manager in the field to carefully and ly observe the exact location of an operator. For instance, if the manager sees that the operator is on the wrong street or route because the operator is lost, the manager can quickly call the operator to give him proper directions to find his route.

Moreover, the software may be enabled to gather notes detailing specific comments about the field as illustrated in FIG. 5h. For instance, if an operator is confronted with a vicious dog, the operator can note the vicious dog into the system in order to alert the next operator who takes that route. Or, for instance if there is an obstacle preventing an accurate read, the operator may note the obstruction so that the client may fix the problem.

FIG. 5f illustrates that in some preferred embodiments the system may also be enabled for re-directing or re-tasking various operators who work as a team in the field. In operation, there may be several operators in the field each assigned with a route. Some routes may be more difficult than others. Some routes may have more or less objects to record. And some operators may be more proficient than others due to their physical attributes or due to inexperience. In the event that one operator is falling behind schedule, a manager in the field may be able to re-assign another operator to assist another operator in their route. For instance if operator 1 has 15 objects to read on route 1 and operator 2 has just finished route 2, the manager may be able to re-assign the remaining objects of route 2 to operator 2. This re-assignment can take place directly through his transceiver.

The system may also, for quality control purposes use standard deviation calculations in order to ensure that a certain read is wrong thereby indicating that either the utility device is broken, there is a leak or hazardous condition, or that there may be a problem with the wand itself. The system may use historical data from a device which calculates an average value taken by that location or object. If the object value is greatly increased or decreased from its historical values and falls outside of a standard deviation, the server may assign a follow-up investigation to either the client or the service provider.

One of the functions of the software is to provide a navigational component which enables operators to navigate their way through routes or task assignments. In some preferred embodiments, the software may use a tree view mode 252 to illustrate the routes. The tree view illustration may appear similar to FIG. 5d.

The software may comprise a global positioning means to enable the server to pinpoint the operator's exact position in real time. Moreover, the software may also comprise a sequential route directing function (illustrated in FIG. 5g) for ensuring that the operator reads the meters in a sequential fashion thereby avoiding confusion, and ensuring an efficient and orderly operation. Server may pre-determine a sequential method of reading meters. For instance, a server may pre-determine the sequence of reading meters in order to decrease the distance an operator must walk. Moreover, the sequence of meter reading may be further altered by the fact that various times of the day may be inaccessible for various routes or meters.

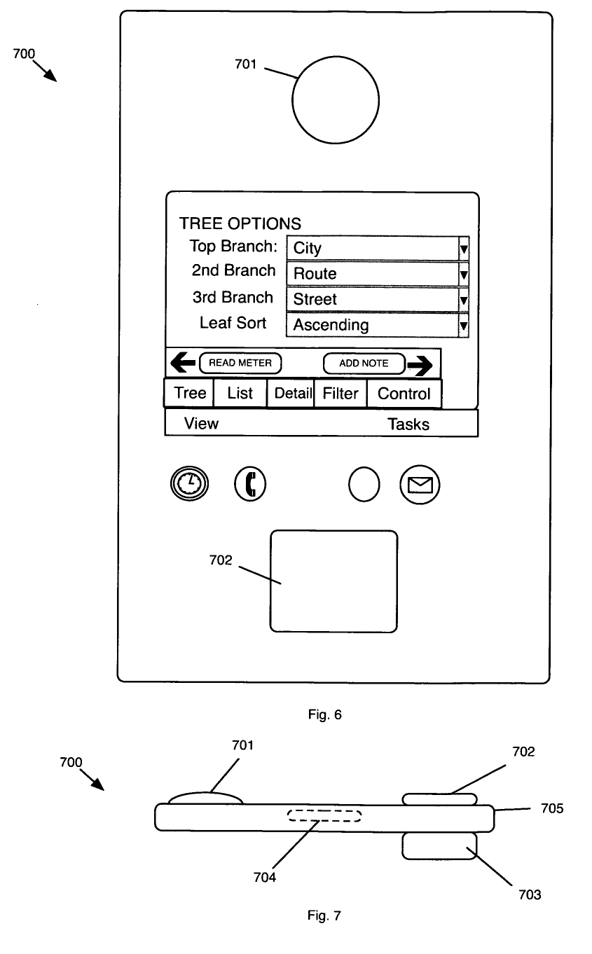

FIGS. 6 and 7 illustrate an exemplary system handheld transceiver 700 to be used in some preferred embodiments. The system handheld transceiver 700 comprises a touchpad 701, a photovoltaic cell 702, a transmitter 703 and a chip 704. The handheld transceiver is housed in a heat, shock, and weather resistant case 705 in some preferred embodiments. It should be pointed out here that the scope of the present invention should not be construed to be limiting with respect to using photovoltaic cells. Other preferred embodiments may alternatively use batteries instead of photovoltaic cells. The touchpad is adaptable with various reading guns, wands, or other data collecting devices such as smartguns. The chip is adaptable with various types of meters.

The transmitter 703 is capable of sending and receiving wireless transmissions for the purpose of disseminating meter readings. Moreover, the transmitter is capable of enabling Internet access. The data collection apparatus may be a wand in some preferred embodiments.

The financial system 104 uses software for processing, and tabulating client and third party information. The financial system incorporates various tasks and functioning such as payroll, bookkeeping, tax calculations, billing, etc. The financial system is designed to be adaptable to many different programs and to be adaptable across various platforms and operating systems.

Those skilled in the art will appreciate numerous variations in the present system, configuration and operation that are within the scope of the invention. Those skilled in the art will also appreciate how the principles illustrated in these preferred embodiments can be used in other examples of the invention. A particular reference number in one figure refers to the same element in all of the other figures.

Moreover, It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. A system and apparatus for collecting, processing, and directing operators in the field in real time comprising:
a client system, a server based management system, and a field transceiver system;
the client system comprises a network-based portal linked to at least one web page for the purpose of interfacing with a client;
a server based management system comprising a server and software;
a field transceiver system comprising at least one handheld transceiver in communication with the server based management system, a data-collecting component, and software for directing the operator through assignments.

2. The system and apparatus of claim 1 for collecting, processing, and directing operators in the field in real time further comprising a security system for the purpose of ensuring authorization and encryption protection.

3. The system and apparatus of claim 1 further comprising a financial system; the financial system comprising software for processing, and tabulating client and third party information.

4. The system and apparatus of claim 1 further comprising software for the purpose of organizing, filtering, tabulating, and processing data gathered in the field according to client's preferred processing guidelines.

5. The system of claim 3 wherein the software comprises instructions for directing the operator, searching for data entries gathered by the operator which exceed standard deviations, and for delegating assignments to the operator(s).

6. The system and apparatus of claim 1 further comprising software for creating and managing task assignments through global positioning components and software.

7. The system, apparatus, and method for collecting, processing, and directing operators in the field in real time further comprising a scanning component for gathering data in the field.

8. The system, apparatus, and method for collecting, processing, and directing operators in the field in real time further comprising instructions for re-assigning tasks or routes to an alternate operator in the field.

9. The system, apparatus, and method for collecting, processing, and directing operators in the field in real time of claim 6 wherein the scanning component is a bar code reader.

10. The system, apparatus, and method for collecting, processing, and directing operators in the field in real time wherein the scanning component is a wand.

11. The system, apparatus, and method for collecting, processing, and directing operators in the field in real time wherein the scanning component is enabled for use with near-field technology.

12. The system, apparatus, and method for collecting, processing, and directing operators in the field in real time of claim 6 wherein the wand is adapted for use in detecting chemical compositions, electricity, or radiation.

13. The system, apparatus, and method for collecting, processing, and directing operators in the field in real time further comprising a global positioning device.

14. The system, apparatus, and method for collecting, processing, and directing operators in the field in real time wherein each transceiver is in communication with other transceivers in operation.

15. The system, apparatus, and method for collecting, processing, and directing operators in the field in real time wherein the transceiver is a multi-function device incorporating a: telecommunications function, a web-browsing function, a laser-enabled bar-code reading function, a computing function, and a radio communications function.

16. The system of claim 1 wherein the handheld transceiver comprises a touchpad, a transmitter, and a photovoltaic cell.

17. A system and apparatus for collecting, processing, and directing operators in the field in real time comprising:
a client system, a server based management system, a financial system, a security system, and a field transceiver system;
the client system comprises a network-based portal linked to at least one web page for the purpose of interfacing with a client;
a server based management system comprising a server and software;
security system for the purpose of ensuring authorization and encryption protection;
the financial system comprising software for processing, and tabulating client and third party information
a field transceiver system comprising at least one handheld transceiver in communication with the server based management system, a data-collecting component, and software for directing the operator through assignments
the handheld transceiver comprises a touchpad, a transmitter, and a photovoltaic cell.

18. The system and apparatus for collecting, processing, and directing operators in the field in real time further comprising a wand.

19. The system and apparatus for collecting, processing, and directing operators in the field in real time further comprising a bar code reader.

20. The system and apparatus for collecting, processing, and directing operators in the field in real time further comprising a global positioning device.
